(19) United States
(12) Patent Application Publication
(10) Pub. No.: US 2018/0288501 A1
(43) Pub. Date: Oct. 4, 2018

(54) DATA REARRANGEMENT METHOD AND APPARATUS, AND STORAGE MEDIUM

(71) Applicant: Sanechips Technology Co., Ltd., Shenzhen, Guangdong (CN)

(72) Inventor: Wenqiong Lin, Shenzhen (CN)

(21) Appl. No.: 15/569,611

(22) PCT Filed: Sep. 28, 2015
(86) PCT No.: PCT/CN2015/090997

§ 371 Date: Oct. 26, 2017

(30) Foreign Application Priority Data
Jun. 17, 2015 (CN) 20151033749.9

(51) Int. Cl. H04Q 3/54

(52) U.S. Cl. CPC H04Q 3/542; H04Q 2213/1332; H04Q 2213/13106; H04Q 2213/1305

(57) ABSTRACT

The disclosure discloses a data rearrangement method. The method includes: determining N/4 4-4 data rearrangement networks in a current N-N rearrangeable non-blocking Benes network; determining sequence numbers of input data of each 4-4 data rearrangement network according to a preset data rearrangement rule; and determining, according to sequence numbers corresponding to input data of switch circuits in the 4-4 data rearrangement networks, a data output mode of the switch circuits, and outputting the input data of the current 4-4 data rearrangement network according to the data output mode corresponding to each switch circuit in the current 4-4 data rearrangement network, N=2ⁿ, and n being a positive integer greater than 1. The disclosure also discloses a data rearrangement apparatus and a storage medium.

### TECHNICAL FIELD

The disclosure relates to the relevant technical field of vector processors in chip design, and in particular to a data rearrangement method and apparatus, and a storage medium.

### BACKGROUND

A Benes network is a rearrangeable non-blocking network, and is well applied to data rearrangement. An N-N Benes network has N items of input data and N items of output data with a total 2 log₂ N−1 level, each level including N/2 switch circuits. Each switch circuit is 2-input and 2-output, and each switch circuit includes two 2-1 selectors. FIG. 1 shows a diagram of an 8-8 Benes network with N=8. Each rectangular block in FIG. 1 is representative of a switch circuit, and an internal circuit of the switch circuit is shown in FIG. 2.

Compared with a common cross bar, the existing Benes network saves more circuit resources. However, more circuit resources are still needed, so the implementation is relatively complicated. Therefore, provision of a data rearrangement solution that can reduce circuit resources of the N-N Benes network and reduce the cost is an urgent problem to be solved.

### SUMMARY

The embodiments of the disclosure are intended to provide a data rearrangement method and apparatus, and a storage medium, which can reduce circuit resources of an N-N Benes network and the cost, and are easy to implement and high in reliability.

The technical solution of the embodiments of the disclosure is implemented as follows.

The embodiment of the disclosure provides a data rearrangement method, which includes:

N/4 4-4 data rearrangement networks in a current N-N Benes network are determined;

sequence numbers of input data of each 4-4 data rearrangement network are determined according to a preset data rearrangement rule; and

a data output mode of the switch circuits is determined according to sequence numbers corresponding to input data of switch circuits in the 4-4 data rearrangement networks, and the input data of the current 4-4 data rearrangement network are output according to the data output mode corresponding to each switch circuit in the current 4-4 data rearrangement network, N=2ⁿ, and n being a positive integer greater than 1.

In the abovementioned solution, determining N/4 4-4 data rearrangement networks in the current N-N Benes network includes:

N/4 4-4 data rearrangement networks are determined in which an ((m−1)/2)^{th} level, an ((m+½)^{th} level and an ((m+3/2)^{th} level of the current N-N Benes network are taken as a first level, a second level and a third level of the 4-4 data rearrangement networks respectively, wherein m is the level number of the current N-N Benes network, and m=2 log₂ N−1.

In the abovementioned solution, after determining N/4 4-4 data rearrangement networks in the current N-N Benes network, the method further includes:

input data and output data of each 4-4 data rearrangement network are acquired.

In the abovementioned solution, determining sequence numbers of input data of each 4-4 data rearrangement network according to the preset data rearrangement rule includes:

the output data of each 4-4 data rearrangement network are sorted in a descending order or ascending order, and sequence numbers of the input data of the corresponding 4-4 data rearrangement network are determined according to sequence numbers of the output data of each 4-4 data rearrangement network.

In the abovementioned solution, determining, according to sequence numbers corresponding to input data of switch circuits in the 4-4 data rearrangement networks, the data output mode of the switch circuits includes:

a sequence number corresponding to second input data in a current switch circuit is compared with a sequence number corresponding to first input data, and it is determined whether a data output mode of the switch circuit is cross output or direct-through output according to a comparison result.

In the abovementioned solution, outputting the input data of the current 4-4 data rearrangement network according to the data output mode corresponding to each switch circuit in the current 4-4 data rearrangement network includes:

according to the data output mode corresponding to each switch circuit in the current 4-4 data rearrangement network, the first output data of a first switch circuit and the first output data of a second switch circuit in the current 4-4 data rearrangement network are taken as the first input data and the second input data of a third switch circuit respectively, the second output data of the first switch circuit and the second output data of the second switch circuit are taken as the first input data and the second input data of a fourth switch circuit respectively, the first output data of the third switch circuit and the second data of the fourth switch circuit are output, the second output data of the third switch circuit and the first output data of the fourth switch circuit are taken as the first input data and the second input data of a fifth switch circuit respectively, and the first output data and the second output data of the fifth switch circuit are output.

The embodiment of the disclosure also provides a data rearrangement apparatus, which includes: a determination module, a sorting module and a processing module, wherein

the determination module is configured to determine N/4 4-4 data rearrangement networks in a current N-N Benes network;

the sorting module is configured to determine sequence numbers of input data of each 4-4 data rearrangement network according to a preset data rearrangement rule; and

the processing module is configured to determine, according to sequence numbers corresponding to input data of switch circuits in the 4-4 data rearrangement networks, a data output mode of the switch circuits, and output the input data of the current 4-4 data rearrangement network according to the data output mode corresponding to each switch circuit in the current 4-4 data rearrangement network, N=2ⁿ, and n being a positive integer greater than 1.

In the abovementioned solution, the determination module is configured to determine N/4 4-4 data rearrangement networks, an ((m−1)/2)^{th} level, an ((m+½)^{th} level and an ((m+3/2)^{th} level of the current N-N Benes network being taken as a first level, a second level and a third level of the 4-4 data rearrangement networks respectively, wherein m is the level number of the current N-N Benes network, and m=2 log₂ N−1.

In the abovementioned solution, the apparatus further includes an acquisition module, configured to acquire input data and output data of each 4-4 data rearrangement network.

In the abovementioned solution, the sorting module is configured to sort the output data of each 4-4 data rearrangement network in a descending order or ascending order, and determine, according to sequence numbers of the output data of each 4-4 data rearrangement network, sequence numbers of the input data of the corresponding 4-4 data rearrangement network.

In the abovementioned solution, the processing module is configured to compare a sequence number corresponding to second input data in a current switch circuit with a sequence number corresponding to first input data, and determine, according to a comparison result, whether a data output mode of the switch circuit is cross output or direct-through output.

In the abovementioned solution, the processing module is configured to take, according to the data output mode corresponding to each switch circuit in the current 4-4 data rearrangement network, the first output data of a first switch circuit and the first output data of a second switch circuit in the current 4-4 data rearrangement network as the first input data and the second input data of a third switch circuit respectively, take the second output data of the first switch circuit and the second output data of the second switch circuit as the first input data and the second input data of a fourth switch circuit respectively, output the first output data of the third switch circuit and the second data of the fourth switch circuit, take the second output data of the third switch circuit and the first output data of the fourth switch circuit as the first input data and the second input data of a fifth switch circuit respectively, and output the first output data and the second output data of the fifth switch circuit.

The embodiment of the disclosure also provides a computer storage medium. A computer program is stored in the computer storage medium. The computer program is configured to execute the data rearrangement method according to the embodiments of the disclosure.

The embodiments of the disclosure provide a data rearrangement method and apparatus and a storage medium. N/4 4-4 data rearrangement networks in a current N-N Benes network are determined; sequence numbers of input data of each 4-4 data rearrangement network are determined according to a preset data rearrangement rule; and according to sequence numbers corresponding to input data of switch circuits in the 4-4 data rearrangement networks, a data output mode of the switch circuits is determined, and the input data of the current 4-4 data rearrangement network is output according to the data output mode corresponding to each switch circuit in the current 4-4 data rearrangement network, N=2ⁿ, and n being a positive integer greater than 1 Thus, a data output mode of a switch circuit is determined through a sequence number corresponding to input data, and the input data of a current 4-4 data rearrangement network is output according to the data output mode corresponding to each switch circuit in the current 4-4 data rearrangement network. Circuit resources of 4-4 data rearrangement networks can be reduced, so that circuit resources of an entire N-N Benes network can be reduced, thereby reducing the implementation cost, and achieving a simple implementation and a high reliability.

### BRIEF DESCRIPTION OF DRAWINGS

FIG. 1 is a diagram of an existing 8-8 Benes network.

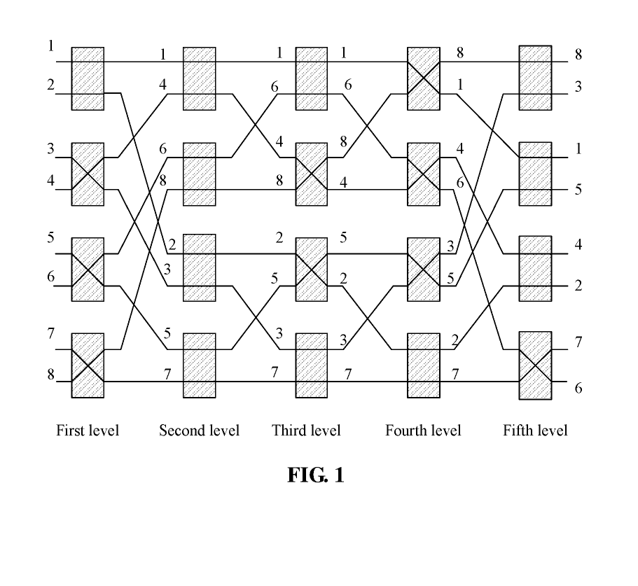

FIG. 2 is a diagram of an internal circuit of a switch circuit in the existing 8-8 Benes network.

FIG. 3 is a flowchart of a data rearrangement method according to Embodiment 1 of the disclosure.

FIG. 4 is a diagram of an 8-8 Benes network according to an embodiment of the disclosure.

FIG. 5 is a flowchart of a data rearrangement method according to Embodiment 2 of the disclosure.

FIG. 6 is a composition structure diagram of a data rearrangement apparatus according to an embodiment of the disclosure.

### DETAILED DESCRIPTION

In the embodiments of the disclosure, N/4 4-4 data rearrangement networks in a current N-N Benes network are determined; sequence numbers of input data of each 4-4 data rearrangement network are determined according to a preset data rearrangement rule; and according to sequence numbers corresponding to input data of switch circuits in the 4-4 data rearrangement networks, a data output mode of the switch circuits is determined, and the input data of the current 4-4 data rearrangement network is output according to the data output mode corresponding to each switch circuit in the current 4-4 data rearrangement network, N=2ⁿ, and n being a positive integer greater than 1.

### Embodiment 1

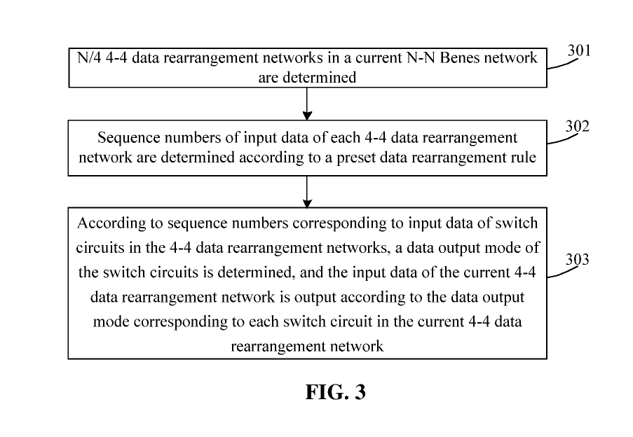

FIG. 3 is a flowchart of a data rearrangement method according to Embodiment 1 of the disclosure. As shown in FIG. 3, the data rearrangement method of the embodiment of the disclosure includes the steps as follows.

In Step 301, N/4 4-4 data rearrangement networks in a current N-N Benes network are determined.

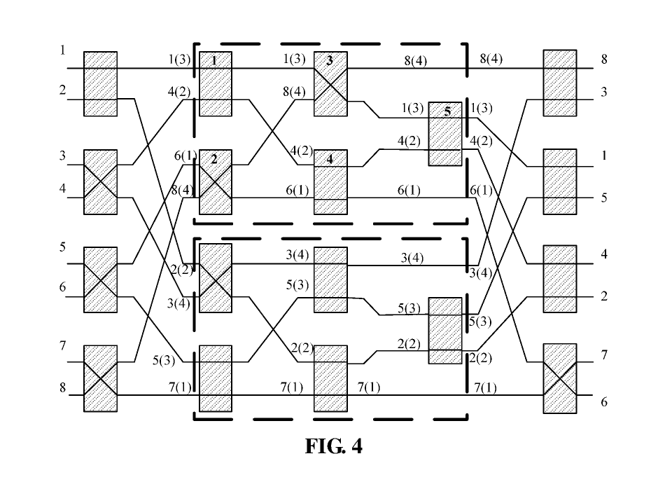

The present step includes: determining N/4 4-4 data rearrangement networks, an ((m−1)/2)^{th} level, an ((m+½)^{th} level and an ((m+3/2)^{th} level of a current N-N Benes network being taken as a first level, a second level and a third level of the 4-4 data rearrangement networks respectively, wherein m is the level number of the current N-N Benes network, and m=2 log₂ N−1. For example, a current 8-8 Benes network is in an m=2 log₂ N−1=5 level, so determined N/4 4-4 data rearrangement networks in the current N-N Benes network are two 4-4 data rearrangement networks, a second level, a third level and a fourth level of the 8-8 Benes network being taken as a first level, a second level and a third level of the two 4-4 data rearrangement networks. FIG. 4 shows a diagram of an 8-8 Benes network according to an embodiment of the disclosure. Parts in two dashed boxes in the figure are the two determined 4-4 data rearrangement networks.

In Step 302, sequence numbers of input data of each 4-4 data rearrangement network are determined according to a preset data rearrangement rule.

The present step includes: the output data of each 4-4 data rearrangement network is sorted in a descending order or ascending order, and sequence numbers of the input data of the corresponding 4-4 data rearrangement network are determined according to sequence numbers of the output data of each 4-4 data rearrangement network.

For example, output data of the current 4-4 data rearrangement network includes 8, 1, 4 and 6. 8, 1, 4 and 6 here may be sequence numbers of actual output data. The output data is sorted to be 8 (4), 1 (3), 4 (2) and 6 (1) according to a descending order. If input data of the 4-4 data rearrangement network includes 1, 4, 6 and 8, wherein 1, 4, 6 and 8 here may be sequence numbers of actual input data, sequence numbers of the input data of the corresponding 4-4 data rearrangement network are determined as: 1 (3), 4 (2), 6 (1) and 8 (4) according to the sequence numbers of the output data of each 4-4 data rearrangement network, wherein the figures between brackets are the sequence numbers of the corresponding data.

In one embodiment, before the present step, the method further includes: acquiring input data and output data of each 4-4 data rearrangement network.

Here, the input data and output data of each 4-4 data rearrangement network may be acquired by using multiple methods in the related art. In the embodiment of the disclosure, the input data and output data of each 4-4 data rearrangement network are acquired by using a method for searching mutually-exclusive pairs.

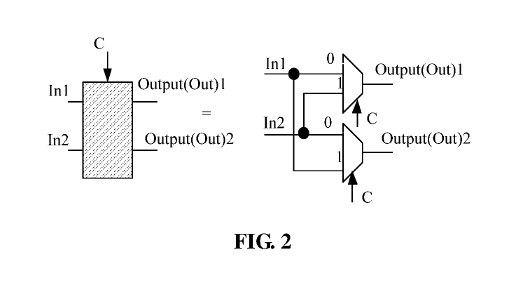

For example, input data of a current 8-8 Benes network includes 1, 2, 3, 4, 5, 6, 7 and 8, and output data finally through a fifth level includes 8, 3, 1, 5, 4, 2, 7 and 6, so input mutually-exclusive pairs are: O1={1, 2}, O2={3, 4}, O3={5, 6} and O4={7, 8}; and output mutually-exclusive pairs are: P1={8, 3}, P2={1, 5}, P3={4, 2} and P4={7, 6}. A data selection process of passing through an upper half path during output of the first level includes: 1 is randomly selected from an input group 1, and if 1 passes through the upper half path after being found in an output group, 5 must pass through a lower half path and cannot be selected accordingly; if 5 is found in the input group, 6 must pass through the upper half path, and 6 is selected; if 6 is found in the output group, 7 must pass through the lower half path and cannot be selected accordingly; if 7 is found in the input group, 8 must pass through the upper half path, and 8 is selected; if 8 is found in the output group, 3 must pass through the lower half path and cannot be selected accordingly; if 3 is found in the input group, 4 must pass through the upper half path, and 4 is selected; thus, data selected in the upper half path through repeated selection of input group-output group-input group-output group includes 1, 4, 6 and 8, the remaining four items of data pass through the lower half path, and then a data output mode of switch circuits in the first level and the fifth level can be determined. Input data of the second level and output data of the fourth level can be further determined, that is, input data and output data of two data rearrangement networks in the current 8-8 Benes network can be determined, wherein the data output mode includes: cross output and direct-through output. As shown in FIG. 2, when out1=int1 and out2=int2, the output is the direct-through output; and when out1=int2 and out2=int1, the output is the cross output.

In one embodiment, in a process of acquiring the input data and output data of each 4-4 data rearrangement network by using a mutually-exclusive pair approach for an N-N Benes network, a data output mode from a first level to an ((m−3)/2)^{th} level and from an ((m+5)/2)^{th} level to an m^{th} level can be determined, and input data from a second level to an ((m−1)/2)^{th} level and output data from an ((m+3)/2)^{th} level to an (m−1)^{th} level can be determined.

In Step 303, according to sequence numbers corresponding to input data of switch circuits in the 4-4 data rearrangement networks, a data output mode of the switch circuits is determined, and the input data of the current 4-4 data rearrangement network is output according to the data output mode corresponding to each switch circuit in the current 4-4 data rearrangement network.

Here, the step of determining, according to sequence numbers corresponding to input data of switch circuits in the 4-4 data rearrangement networks, a data output mode of the switch circuits includes:

a sequence number corresponding to second input data in a current switch circuit is compared with a sequence number corresponding to first input data, and it is determined whether a data output mode of the switch circuit is cross output or direct-through output according to a comparison result.

Wherein, the step of determining, according to a comparison result, whether a data output mode of the switch circuit is cross output or direct-through output includes:

if the sequence number corresponding to the second input data is greater than the sequence number corresponding to the first input data, that is, in2>in1, the data output mode of the switch circuit is determined as the cross output; and otherwise, the data output mode of the switch circuit is determined as the direct-through output. For example, the sequence number corresponding to the second input data in the current switch circuit is 2, and the sequence number corresponding to the first input data is 3, so the data output mode of the switch circuit is determined as the direct-through output.

In one embodiment, the step of outputting the input data of the current 4-4 data rearrangement network according to the data output mode corresponding to each switch circuit in the current 4-4 data rearrangement network includes:

according to the data output mode corresponding to each switch circuit in the current 4-4 data rearrangement network, the first output data of a first switch circuit and the first output data of a second switch circuit in the current 4-4 data rearrangement network are taken as the first input data and the second input data of a third switch circuit respectively; the second output data of the first switch circuit and the second output data of the second switch circuit are taken as the first input data and the second input data of a fourth switch circuit respectively; the first output data of the third switch circuit and the second data of the fourth switch circuit are output; the second output data of the third switch circuit and the first output data of the fourth switch circuit are taken as the first input data and the second input data of a fifth switch circuit respectively; and the first output data and the second output data of the fifth switch circuit are output. Thus, a data output mode of a switch circuit is determined through a sequence number corresponding to the input data, and the input data of a current 4-4 data rearrangement network is output according to the data output mode corresponding to each switch circuit in the current 4-4 data rearrangement network. Compared with the existing Benes network, each 4-4 data rearrangement network saves a switch circuit resource. From the comparison of FIG. 2 with FIG. 4, it can be obviously seen that for an 8-8 Benes network, compared with the existing 8-8 Benes network, the data rearrangement method according to the embodiment of the disclosure can save two switch circuit resources, namely four selector resources. Further, for an N-N Benes network, compared with the existing N-N Benes network, the data rearrangement method according to the embodiment of the disclosure can save N/4 switch circuit resources, namely N/2 selector resources.

In the embodiment of the disclosure, when the input data of the current 4-4 data rearrangement network is output, by using a data output mode, determined by mutually-exclusive pairs, from the first level to the ((m−3)/2)^{th} level and from the ((m+5)/2)^{th} level to the m^{th} level, preset output data of the current N-N Benes network can be output.

### Embodiment 2

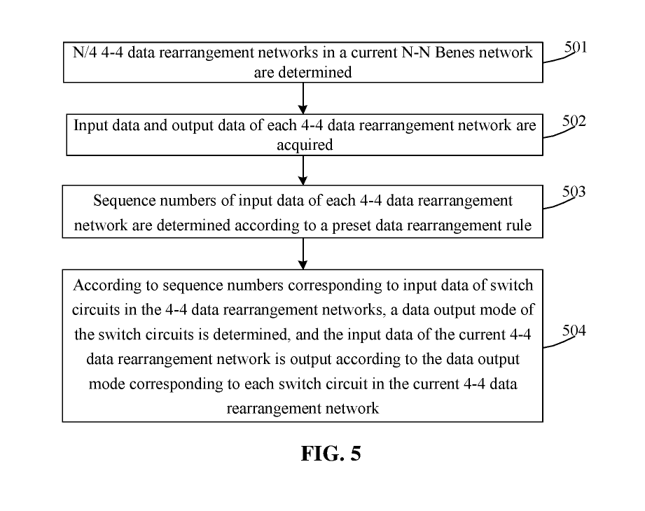

FIG. 5 is a flowchart of a data rearrangement method according to Embodiment 2 of the disclosure. As shown in FIG. 5, the data rearrangement method of the embodiment of the disclosure includes the steps as follows.

In Step 501, N/4 4-4 data rearrangement networks in a current N-N Benes network are determined.

The present step includes: determining N/4 4-4 data rearrangement networks, an ((m−1)/2)^{th} level, an ((m+½)^{th} level and an ((m+3/2)^{th} level of a current N-N Benes network being taken as a first level, a second level and a third level of the 4-4 data rearrangement networks respectively, wherein m is the number of levels of the current N-N Benes network, and m=2 log₂ N−1.

In the present embodiment, the N-N Benes network is a 16-16 Benes network, and is in an m=2 log₂N−1=7 level, so four determined 4-4 data rearrangement networks in the current 16-16 Benes network are four 4-4 data rearrangement networks in which a third level, a fourth level and a fifth level of the 16-16 Benes network are taken as a first level, a second level and a third level of the 4-4 data rearrangement networks.

In Step 502, input data and output data of each 4-4 data rearrangement network are acquired.

Here, the input data and output data of each 4-4 data rearrangement network may be acquired by using multiple methods in the related art. In the embodiment of the disclosure, the input data and output data of each 4-4 data rearrangement network are acquired by using a method for searching mutually-exclusive pairs.

Data is selected in an upper half path through repeated selection of input group-output group-input group-output group by using the mutually-exclusive pair method, the remaining data passes through a lower half path, and then a data output mode of switch circuits in the first level and the seven level, and in the second level and the sixth level can be determined. Input data of the third level and output data of the fifth level can be further determined, that is, input data and output data of four data rearrangement networks in the current 16-16 Benes network can be determined, wherein the data output mode includes: cross output and direct-through output. As shown in FIG. 2, when out1=int1 and out2=int2, the output is the direct-through output; and when out1=int2 and out2=int1, the output is the cross output.

In Step 503, sequence numbers of input data of each 4-4 data rearrangement network are determined according to a preset data rearrangement rule.

The present step includes: sorting the output data of each 4-4 data rearrangement network in a descending order or ascending order, and determining, according to sequence numbers of the output data of each 4-4 data rearrangement network, sequence numbers of the input data of the corresponding 4-4 data rearrangement network.

For example, obtained output data of the current 4-4 data rearrangement network includes 8, 1, 4 and 6. 8, 1, 4 and 6 here may be sequence numbers of actual output data. The output data is sorted to be 8 (1), 1 (2), 4 (3) and 6 (4) according to an ascending order. If obtained input data of the 4-4 data rearrangement network includes 1, 4, 6 and 8, wherein 1, 4, 6 and 8 here may be sequence numbers of actual input data, sequence numbers of the input data of the corresponding 4-4 data rearrangement network are determined as: 1 (2), 4 (3), 6 (4) and 8 (1) according to the sequence numbers of the output data of each 4-4 data rearrangement network, wherein the figures between brackets are the sequence numbers of the corresponding data.

In Step 504, according to sequence numbers corresponding to input data of switch circuits in the 4-4 data rearrangement networks, a data output mode of the switch circuits is determined, and the input data of the current 4-4 data rearrangement network is output according to the data output mode corresponding to each switch circuit in the current 4-4 data rearrangement network.

Here, the step of determining, according to sequence numbers corresponding to input data of switch circuits in the 4-4 data rearrangement networks, a data output mode of the switch circuits includes:

a sequence number corresponding to second input data in a current switch circuit is compared with a sequence number corresponding to first input data, and it is determined, according to a comparison result, whether a data output mode of the switch circuit is cross output or direct-through output.

Wherein, the step of determining, according to a comparison result, whether a data output mode of the switch circuit is cross output or direct-through output includes:

if the sequence number corresponding to the second input data is greater than the sequence number corresponding to the first input data, that is, in2>in1, the data output mode of the switch circuit is determined as the cross output; and otherwise, the data output mode of the switch circuit is determined as the direct-through output. For example, the sequence number corresponding to the second input data in the current switch circuit is 3, and the sequence number corresponding to the first input data is 2, so the data output mode of the switch circuit is determined as the cross output.

In one embodiment, the step of outputting the input data of the current 4-4 data rearrangement network according to the data output mode corresponding to each switch circuit in the current 4-4 data rearrangement network includes:

according to the data output mode corresponding to each switch circuit in the current 4-4 data rearrangement network, the first output data of a first switch circuit and the first output data of a second switch circuit in the current 4-4 data rearrangement network are taken as the first input data and the second input data of a third switch circuit respectively; the second output data of the first switch circuit and the second output data of the second switch circuit are taken as the first input data and the second input data of a fourth switch circuit respectively; the first output data of the third switch circuit and the second data of the fourth switch circuit are output; the second output data of the third switch circuit and the first output data of the fourth switch circuit are taken as the first input data and the second input data of a fifth switch circuit respectively; and the first output data and the second output data of the fifth switch circuit are output. Thus, in the present embodiment, by using a data output mode in the sixth level and the seventh level, determined by the method for searching mutually-exclusive pairs, preset output data of the current 16-16 Benes network can be output.

### Embodiment 3

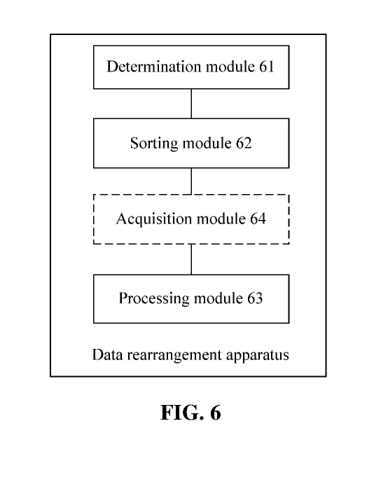

FIG. 6 is a composition structure diagram of a data rearrangement apparatus according to an embodiment of the disclosure. As shown in FIG. 6, the data rearrangement apparatus according to the embodiment of the disclosure includes: a determination module 61, a sorting module 62 and a processing module 63, wherein

the determination module 61 is configured to determine N/4 4-4 data rearrangement networks in a current N-N Benes network;

the sorting module 62 is configured to determine sequence numbers of input data of each 4-4 data rearrangement network according to a preset data rearrangement rule; and

the processing module 63 is configured to determine, according to sequence numbers corresponding to input data of switch circuits in the 4-4 data rearrangement networks, a data output mode of the switch circuits, and output the input data of the current 4-4 data rearrangement network according to the data output mode corresponding to each switch circuit in the current 4-4 data rearrangement network, N=2ⁿ, and n being a positive integer greater than 1.

In one embodiment, the determination module 61 is configured to determine N/4 4-4 data rearrangement networks, an ((m−1)/2)^{th} level, an ((m+½)^{th} level and an ((m+3/2)^{th} level of a current N-N Benes network being taken as a first level, a second level and a third level of the 4-4 data rearrangement networks respectively, wherein m is the level number of the current N-N Benes network, and m=2 log₂ N−1. For example, a current 8-8 Benes network is in an m=2 log₂ N−1=5 level, so determined N/4 4-4 data rearrangement networks in the current N-N Benes network are two 4-4 data rearrangement networks, a second level, a third level and a fourth level of the 8-8 Benes network being taken as a first level, a second level and a third level of the 4-4 data rearrangement networks. FIG. 4 shows a diagram of an 8-8 Benes network according to an embodiment of the disclosure. Parts in two dashed boxes in the figure are the two determined 4-4 data rearrangement networks.

In one embodiment, the apparatus further includes an acquisition module 64, configured to acquire input data and output data of each 4-4 data rearrangement network.

The acquisition module 64 is configured to acquire the input data and output data of each 4-4 data rearrangement network by using a method for searching mutually-exclusive pairs. Correspondingly, the acquisition module 74 is further configured to determine the following: a data output mode from a first level to an ((m−3)/2)^{th} level and from an ((m+5)/2)^{th} level to an m^{th} level, input data from a second level to an ((m−1)/2)^{th} level, and output data from an ((m+3)/2)^{th} level to an (m−1)^{th} level of the current N-N Benes network.

In one embodiment, the sorting module 62 is configured to sort the output data of each 4-4 data rearrangement network in a descending order or ascending order, and determine, according to sequence numbers of the output data of each 4-4 data rearrangement network, sequence numbers of the input data of the corresponding 4-4 data rearrangement network.

For example, output data of the current 4-4 data rearrangement network includes 8, 1, 4 and 6. 8, 1, 4 and 6 here may be sequence numbers of actual output data. The output data is sorted to be 8 (4), 1 (3), 4 (2) and 6 (1) according to a descending order. If input data of the 4-4 data rearrangement network includes 1, 4, 6 and 8, wherein 1, 4, 6 and 8 here may be sequence numbers of actual input data, sequence numbers of the input data of the corresponding 4-4 data rearrangement network are determined as: 1 (3), 4 (2), 6 (1) and 8 (4) according to the sequence numbers of the output data of each 4-4 data rearrangement network, wherein the figures between brackets are the sequence numbers of the corresponding data.

In one embodiment, the processing module 63 is configured to compare a sequence number corresponding to second input data in a current switch circuit with a sequence number corresponding to first input data, and determine, according to a comparison result, whether a data output mode of the switch circuit is cross output or direct-through output.

Wherein, the operation that the processing module 63 determines, according to a comparison result, whether a data output mode of the switch circuit is cross output or direct-through output includes:

when the processing module 63 determines that the sequence number corresponding to the second input data is greater than the sequence number corresponding to the first input data, that is, in2>in1, the processing module 63 determines the data output mode of the switch circuit as cross output, and otherwise, determines the data output mode of the switch circuit as direct-through output.

In one embodiment, the processing module 63 is configured to take, according to the data output mode corresponding to each switch circuit in the current 4-4 data rearrangement network, first output data of a first switch circuit and first output data of a second switch circuit in the current 4-4 data rearrangement network as first input data and second input data of a third switch circuit respectively, take second output data of the first switch circuit and second output data of the second switch circuit as first input data and second input data of a fourth switch circuit respectively, output first output data of the third switch circuit and second data of the fourth switch circuit, take second output data of the third switch circuit and first output data of the fourth switch circuit as first input data and second input data of a fifth switch circuit respectively, and output first output data and second output data of the fifth switch circuit.

In one embodiment, the processing module 63 is further configured to control preset output data of the current N-N Benes network to be output by means of a data output mode determined from the first level to the ((m−3)/2)^{th} level and from the ((m+5)/2)^{th} level to the m^{th} level.

The determination module, the sorting module, the processing module and the acquisition module provided in the embodiment of the disclosure may be implemented by means of a processor, and may be, certainly, implemented by means of a specific logic circuit, wherein the processor may be a processor on a mobile terminal or a server. In a practical application, the processor may be a Central Processing Unit (CPU), a Micro Processing Unit (MPU), a Digital Signal Processor (DSP) or a Field-Programmable Gate Array (FPGA).

In the embodiments of the disclosure, if the data rearrangement method is implemented in a form of software function module and is sold or used as an independent product, the product may also be stored in a computer-readable storage medium. Based on this understanding, the technical solutions of the embodiments of the disclosure may be substantially embodied in a form of software product or parts contributing to the related art may be embodied in a form of software product, and the computer software product is stored in a storage medium, which includes a plurality of instructions enabling a computer device (which may be a personal computer, a server or a network device) to execute all or part of the method according to each embodiment of the disclosure. The storage medium includes: various media capable of storing program codes, such as a U disk, a mobile hard disk, a Read Only Memory (ROM), a magnetic disk or an optical disk. Thus, the embodiments of the disclosure are not limited to combination of any specific hardware and software.

Correspondingly, the embodiment of the disclosure also provides a computer storage medium. A computer program is stored in the computer storage medium. The computer program is configured to execute the data rearrangement method according to the embodiments of the disclosure.

The above is only the preferable embodiments of the disclosure and not used to limit the scope of protection of the disclosure.

1. A data rearrangement method, comprising:
determining N/4 4-4 data rearrangement networks in a current N-N Benes network;
determining sequence numbers of input data of each 4-4 data rearrangement network according to a preset data rearrangement rule; and
determining, according to sequence numbers corresponding to input data of switch circuits in the 4-4 data rearrangement networks, a data output mode of the switch circuits, and outputting the input data of the current 4-4 data rearrangement network according to the data output mode corresponding to each switch circuit in the current 4-4 data rearrangement network, N=2ⁿ, and n being a positive integer greater than 1.

2. The method according to claim 1, wherein determining N/4 4-4 data rearrangement networks in the current N-N Benes network comprises:
determining N/4 4-4 data rearrangement networks, an ((m−1)/2)^{th} level, an ((m+½)^{th} level and an ((m+3/2)^{th} level of the current N-N Benes network being taken as a first level, a second level and a third level of the 4-4 data rearrangement networks respectively, wherein m is the level number of the current N-N Benes network, and m=2 log₂ N−1.

3. The method according to claim 1, wherein after determining N/4 4-4 data rearrangement networks in the current N-N Benes network, the method further comprises:
acquiring input data and output data of each 4-4 data rearrangement network.

4. The method according to claim 1, wherein determining sequence numbers of input data of each 4-4 data rearrangement network according to the preset data rearrangement rule comprises:
sorting the output data of each 4-4 data rearrangement network in a descending order or ascending order, and determining, according to sequence numbers of the output data of each 4-4 data rearrangement network, sequence numbers of the input data of the corresponding 4-4 data rearrangement network.

5. The method according to claim 1, wherein determining, according to sequence numbers corresponding to input data of switch circuits in the 4-4 data rearrangement networks, the data output mode of the switch circuits comprises:
comparing a sequence number corresponding to second input data in a current switch circuit with a sequence number corresponding to first input data, and determining, according to a comparison result, whether the data output mode of the switch circuit is cross output or direct-through output.

6. The method according to claim 1, wherein outputting the input data of the current 4-4 data rearrangement network according to the data output mode corresponding to each switch circuit in the current 4-4 data rearrangement network comprises:
taking, according to the data output mode corresponding to each switch circuit in the current 4-4 data rearrangement network, first output data of a first switch circuit and first output data of a second switch circuit in the current 4-4 data rearrangement network as first input data and second input data of a third switch circuit respectively, taking second output data of the first switch circuit and second output data of the second switch circuit as first input data and second input data of a fourth switch circuit respectively, outputting first output data of the third switch circuit and second data of the fourth switch circuit, taking second output data of the third switch circuit and first output data of the fourth switch circuit as first input data and second input data of a fifth switch circuit respectively, and outputting first output data and second output data of the fifth switch circuit.

7. A data rearrangement apparatus, comprising:
a processor; and
a memory for storing computer-readable instructions executable for the processor;
wherein when the computer-readable operation instructions are executed, the processor is configured to:
determine N/4 4-4 data rearrangement networks in a current N-N Benes network;
determine sequence numbers of input data of each 4-4 data rearrangement network according to a preset data rearrangement rule; and
determine, according to sequence numbers corresponding to input data of switch circuits in the 4-4 data rearrangement networks, a data output mode of the switch circuits, and output the input data of the current 4-4 data rearrangement network according to the data output mode corresponding to each switch circuit in the current 4-4 data rearrangement network, N=2ⁿ, and n being a positive integer greater than 1.

8. The apparatus according to claim 7, wherein the processor is further configured to determine N/4 4-4 data rearrangement networks, an ((m−1)/2)^{th} level, an ((m+½)^{th} level and an ((m+3/2)^{th} level of the current N-N Benes network being taken as a first level, a second level and a third level of the 4-4 data rearrangement networks respectively, wherein m is the level number of the current N-N Benes network, and m=2 log₂ N−1.

9. The apparatus according to claim 7, wherein the processor is further configured to acquire input data and output data of each 4-4 data rearrangement network.

10. The apparatus according to claim 7, wherein the processor is further configured to sort the output data of each 4-4 data rearrangement network in a descending order or ascending order, and determine, according to sequence numbers of the output data of each 4-4 data rearrangement network, sequence numbers of the input data of the corresponding 4-4 data rearrangement network.

11. The apparatus according to claim 7, wherein the processor is further configured to compare a sequence number corresponding to second input data in a current switch circuit with a sequence number corresponding to first input data, and determine, according to a comparison result, whether the data output mode of the switch circuit is cross output or direct-through output.

12. The apparatus according to claim 7, wherein the processor is further configured to take, according to the data output mode corresponding to each switch circuit in the current 4-4 data rearrangement network, first output data of a first switch circuit and first output data of a second switch circuit in the current 4-4 data rearrangement network as first input data and second input data of a third switch circuit respectively, take second output data of the first switch circuit and second output data of the second switch circuit as first input data and second input data of a fourth switch circuit respectively, output first output data of the third switch circuit and second data of the fourth switch circuit, take second output data of the third switch circuit and first output data of the fourth switch circuit as first input data and second input data of a fifth switch circuit respectively, and output first output data and second output data of the fifth switch circuit.

13. A non-transitory computer-readable storage medium having stored thereon computer-executable instructions that, when executed by a processor, causes the processor to perform a data rearrangement method, the method comprising:
determining N/4 4-4 data rearrangement networks in a current N-N Benes network;
determining sequence numbers of input data of each 4-4 data rearrangement network according to a preset data rearrangement rule; and
determining, according to sequence numbers corresponding to input data of switch circuits in the 4-4 data rearrangement networks, a data output mode of the switch circuits, and outputting the input data of the current 4-4 data rearrangement network according to the data output mode corresponding to each switch circuit in the current 4-4 data rearrangement network, N=2ⁿ, and n being a positive integer greater than 1.

14. The non-transitory computer-readable storage medium according to claim 13, wherein determining N/4 4-4 data rearrangement networks in the current N-N Benes network comprises:
determining N/4 4-4 data rearrangement networks, an ((m−1)/2)^{th} level, an ((m+½)^{th} level and an ((m+3/2)^{th} level of the current N-N Benes network being taken as a first level, a second level and a third level of the 4-4 data rearrangement networks respectively, wherein m is the level number of the current N-N Benes network, and m=2 log₂ N−1.

15. The non-transitory computer-readable storage medium according to claim 13, wherein after determining N/4 4-4 data rearrangement networks in the current N-N Benes network, the method further comprises:
acquiring input data and output data of each 4-4 data rearrangement network.

16. The non-transitory computer-readable storage medium according to claim 13, wherein determining sequence numbers of input data of each 4-4 data rearrangement network according to the preset data rearrangement rule comprises:
sorting the output data of each 4-4 data rearrangement network in a descending order or ascending order, and determining, according to sequence numbers of the output data of each 4-4 data rearrangement network, sequence numbers of the input data of the corresponding 4-4 data rearrangement network.

17. The non-transitory computer-readable storage medium according to claim 13, wherein determining, according to sequence numbers corresponding to input data of switch circuits in the 4-4 data rearrangement networks, the data output mode of the switch circuits comprises:
comparing a sequence number corresponding to second input data in a current switch circuit with a sequence number corresponding to first input data, and determining, according to a comparison result, whether the data output mode of the switch circuit is cross output or direct-through output.

18. The non-transitory computer-readable storage medium according to claim 13, wherein outputting the input data of the current 4-4 data rearrangement network according to the data output mode corresponding to each switch circuit in the current 4-4 data rearrangement network comprises:
taking, according to the data output mode corresponding to each switch circuit in the current 4-4 data rearrangement network, first output data of a first switch circuit and first output data of a second switch circuit in the current 4-4 data rearrangement network as first input data and second input data of a third switch circuit respectively, taking second output data of the first switch circuit and second output data of the second switch circuit as first input data and second input data of a fourth switch circuit respectively, outputting first output data of the third switch circuit and second data of the fourth switch circuit, taking second output data of the third switch circuit and first output data of the fourth switch circuit as first input data and second input data of a fifth switch circuit respectively, and outputting first output data and second output data of the fifth switch circuit.
